(19) United States
(12) Patent Application Publication
(10) Pub. No.: US 2024/0142573 A1
(43) Pub. Date: May 2, 2024

(54) COMPUTER-IMPLEMENTED METHOD AND DEVICE FOR DETERMINING A CLASSIFICATION FOR AN OBJECT

(71) Applicant: Robert Bosch GmbH, Stuttgart (DE)

(72) Inventors: Gor Hakobyan, Schoenaich (DE); Christian Weiss, Leonberg (DE); Kilian Rambach, Stuttgart (DE)

(21) Appl. No.: 18/493,779

(22) Filed: Oct. 24, 2023

(30) Foreign Application Priority Data
Oct. 28, 2022 (DE) 10 2022 211 463.9

(51) Int. Cl. G01S 7/41

(52) U.S. Cl. CPC G01S 7/412; G01S 7/417

(57) ABSTRACT

A method and device for determining a classification for an object. The device is designed to provide pixels of a radar image that are assigned to the object, wherein the device is designed to provide a point cloud, wherein the point cloud comprises at least one point that represents a radar reflection assigned to the object, through at least one property assigned to the object, wherein the device is designed to extract first features that characterize the object, from the pixels, to extract second features that characterize the object, from the point cloud, and to determine the classification of the object depending on the first features and the second features.

### FIELD

The present invention relates to a computer-implemented method and to a device for determining a classification for an object.

### BACKGROUND INFORMATION

Conventional methods and devices, for example, classify objects depending on radar spectra or radar reflections, or both.

### SUMMARY

A computer-implemented method and device for determining a classification for an object according to features of the present invention achieve an improved classification.

According to an example embodiment of the present invention, the method includes providing pixels of a radar image that are assigned to the object, and providing a point cloud, wherein the point cloud comprises at least one point that represents a radar reflection assigned to the object, through at least one property assigned to the object, wherein first features that characterize the object are extracted from the pixels, wherein second features that characterize the object are extracted from the point cloud, wherein a classification of the object is determined depending on the first features and the second features.

The radar image characterizes a radar spectrum. The pixels represent cells in the radar spectrum. The pixels characterize a region of interest (ROI) of the radar spectrum that is associated with the object. The point cloud comprises points that respectively define a radar reflection through their property. In the example, a position of a point is specified in a radial coordinate system with respect to a sensor for determining the radar image. The position is, for example, given by a radial distance from the sensor and an angle to the direction of view of the sensor; in the case of a vehicle, its driving direction, for example. In addition, each point has further features, which are referred to as property below. For further processing, the point may also be transformed into a Cartesian coordinate system with respect to the sensor or the vehicle. The point cloud contains all points associated with the same object. The coordinates of a point in the radar image are used to determine the pixels in the radar image that are associated with the object. The property includes, for example, information about the radar reflection of the object, in particular a speed of a movement of the radar reflection, the position of the radar reflection within the point cloud, e.g., longitudinal and transverse distance from the center of the point cloud, a target angle of the radar reflection, the backscatter cross-section thereof, or a height of the radar reflection. The radar image comprises distance, velocity, and amplitude information for objects, including the targets that could not be resolved. Thus, both inputs have additional information that improves the classification.

According to an example embodiment of the present invention, it may be provided that the pixels are mapped to the first features by means of a first neural network trained for this purpose, wherein the point cloud is mapped to the second features by means of a second neural network trained for this purpose, and wherein an input variable is determined depending on the first features and the second features, wherein the input variable is mapped to the classification by means of a third neural network trained for this purpose. The first features are extracted from the first neural network. The second features are extracted from the second neural network. The information contained jointly in them improves the classification by the third neural network.

According to an example embodiment of the present invention, it may be provided that the first neural network and the second neural network and the third neural network are trained independently of one another or that at least two of these networks are trained jointly.

According to an example embodiment of the present invention, it may be provided that raw data for determining the radar image are sensed by a sensor, wherein the radar image is determined depending on the raw data sensed.

According to an example embodiment of the present invention, it may be provided that a signal for controlling at least one actuator is determined depending on the classification.

According to an example embodiment of the present invention, the device for determining a classification for an object is designed to provide pixels of a radar image that are assigned to the object, wherein the device is designed to provide a point cloud, wherein the point cloud comprises at least one point that represents a radar reflection assigned to the object, through at least one property assigned to the object, wherein the device is designed to extract first features that characterize the object, from the pixels, to extract second features that characterize the object, from the points, and to determine a classification of the object depending on the first features and the second features.

According to an example embodiment of the present invention, it is preferably provided that the device is designed to map the pixels to the first features by means of a first neural network trained for this purpose, to map the point cloud to the second features by means of a second neural network trained for this purpose, and to determine an input variable depending on the first features and the second features, and to map the input variable to the classification by means of a third neural network trained for this purpose.

According to an example embodiment of the present invention, it may be provided that the device is designed to train the first neural network and the second neural network and the third neural network independently of one another, or to jointly train at least two of these networks.

A program comprising machine-readable instructions that, when executed by a machine, cause the method according to the present invention to run has advantages corresponding to those of the method.

Further advantageous embodiments of the present invention can be taken from the following description and the figures.

### BRIEF DESCRIPTION OF THE DRAWINGS

FIG. 1 shows a schematic representation of a device for determining a classification, according to an example embodiment of the present invention.

FIG. 2 shows a schematic representation of a model for determining the classification, according to an example embodiment of the present invention.

FIG. 3 shows steps in a method for determining the classification, according to an example embodiment of the present invention.

### DETAILED DESCRIPTION OF EXAMPLE EMBODIMENTS

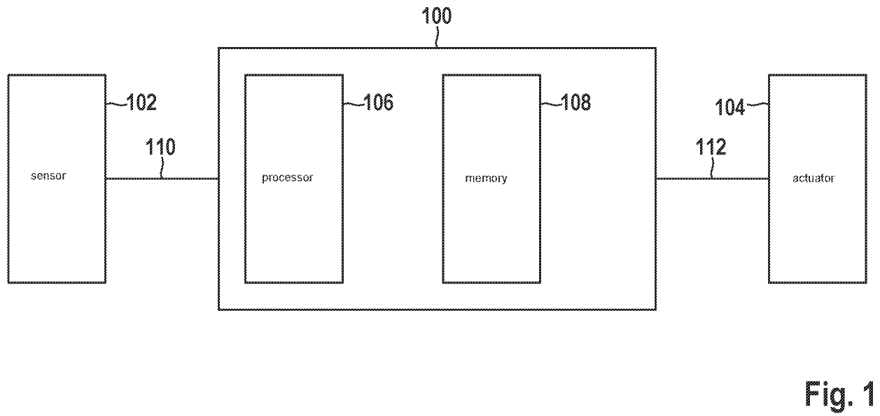

FIG. 1 schematically shows a device 100 for determining a classification of an object.

The device 100 is designed to process raw data of a sensor 102 from which a radar image, i.e., a radar spectrum, and, if present, a radar reflection in the radar image can be determined. The sensor 102 is designed to sense the raw data. It may be provided that the device 100 comprises the sensor 102.

The device 100 is designed to determine a signal for controlling at least one actuator 104. It may be provided that the device 100 comprises the at least one actuator 104.

For example, the device 100 comprises at least one processor 106 and at least one memory 108. The at least one processor 106 is designed to execute a program for determining the classification, for determining the radar image from the raw data, for determining the radar reflection from the radar image, and/or for determining the control signal depending on the classification. For this purpose, the program, for example, comprises instructions, i.e., machine-readable instructions, that can be read by the at least one processor 106. The program is, for example, stored in at least one memory 108.

In the example, the at least one sensor 102 is connected to the device 100 via a sensor line 110 for transmitting the raw data sensed. In the example, the at least one actuator 104 is connected via a signal line 112 to the device 100 for the purpose of transmitting the signal.

The radar image is, for example, a range doppler, a range speed, a range azimuth, or a four-dimensional radar image that specifies the distance, speed, elevation angle, and azimuth angle that are assigned to pixels in the radar image.

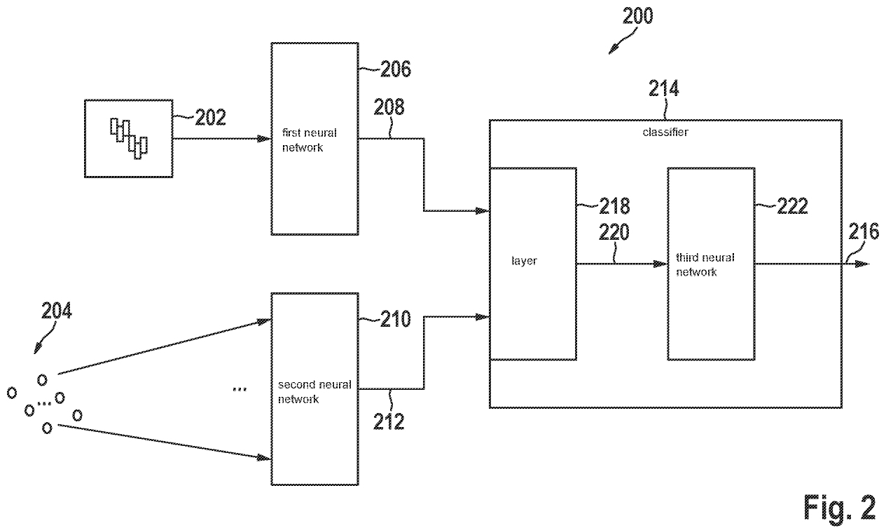

FIG. 2 schematically shows a model 200 for determining the classification.

In the example, the at least one memory 108 is designed to store the model 200.

The device 100 is designed to provide the pixels 202 of the radar image that are assigned to the object, depending on the radar image.

The device 100 is designed to provide the radar reflection 204 assigned to the object, from the radar image.

The device 100 is designed to provide at least one property assigned to the object, per radar reflection. The at least one property includes, for example, information about the radar reflection, the distance thereof to other radar reflections, a speed of a movement of the radar reflection, a target angle of the radar reflection, the backscatter cross-section thereof, or a height of the radar reflection.

In the example, the device 100 comprises a first neural network 206 for mapping the pixels 202 to first features 208. This means that the device 100 is designed to extract first features 208 that characterize the object, from the pixels. The pixels are portions of a region of interest, ROI, that comprises the object. In the example, the first neural network is part of a network optimized for the classification of images. In the example, the first neural network comprises the layers of the network optimized for the classification of images.

For example, the first neural network 206 is a convolutional network.

In the example, the device 100 comprises a second neural network 210 for mapping a point cloud to second features 212.

The point cloud comprises points that respectively represent a radar reflection through at least one property. The property and the radar reflection are assigned to the same object.

This means that the device 100 is designed to extract second features 212 that characterize the object, from the radar reflections assigned to the object. In the example, the second neural network 210 is part of a network optimized for the classification of point clouds. In the example, the second neural network 210 comprises the layers of the network optimized for the classification of point clouds.

The second neural network 210 is, for example, designed as a PointNet. For example, the second neural network 210 is designed as described in “DeepReflecs: Deep Learning for Automotive Object Classification with Radar Reflections,” Michael Ulrich, Claudius Glaser, Fabian Timm, arxiv.org/abs/2010.09273.

For example, the PointNet is designed as described in “PointNet: Deep Learning on Point Sets for 3D Classification and Segmentation,” Charles R. Qi, Hao Su, Kaichun Mo, Leonidas J. Guibas, arxiv.org/abs/1612.00593.

In the example, the device 100 comprises a classifier 214 for determining a classification 216 depending on the first features 208 and the second features 212. In the example, the classifier 214 comprises a layer 218 for concatenating the first features 208 and the second features 212 into an input variable 220 for a third neural network 222. The third neural network 222 is designed to map the input variable 220 to the classification 216.

The features extracted from both inputs of the two neural networks are, for example, extracted in a layer of the respective neural networks directly preceding a classification layer or several classification layers, i.e., a classification head of the respective neural network.

The features extracted from both inputs of the two neural networks are, for example, feature vectors that are merged to form one vector. This vector serves as input for the third neural network 222. For example, the third neural network 22 comprises dense layers, which perform the classification 216 of the object type. The dense layers may generally also be supplemented or replaced by other layers of a neural network. In the example, the third neural network 222 comprises one or more classification layers.

The device 100 is designed to determine the classification 216 of the object depending on the first features 208 and the second features 212.

For example, the first and second neural networks 206 and 210 are pre-trained with a classification head each for classifying objects depending on images or point clouds. The neural networks 206 and 210 can be pre-trained separately. Alternatively, they can be trained jointly. It may be provided that the third neural network 222 is trained jointly or independently of the two other networks. For example, the neural networks 206, 210, 222 are pre-trained with a data set to classify objects into object classes with the classification 216. The object classes are, for example, car, pedestrian, object that can be driven over, two-wheeler, and object that can be driven under.

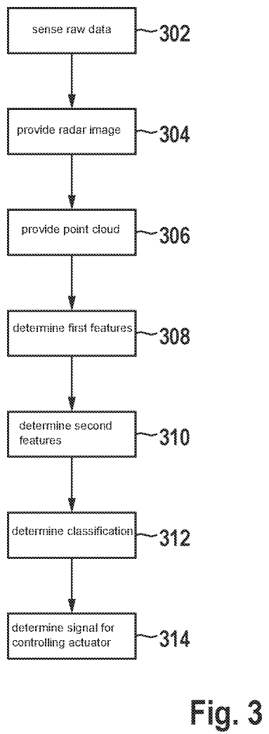

FIG. 3 shows steps in a method for determining the classification for an object.

The method optionally comprises a step 302.

In step 302, the raw data are sensed by means of the sensor 102. For example, the raw data are sensed during operation of the vehicle.

The method comprises a step 304.

In step 304, the radar image is provided. It may be provided that the radar image is determined depending on the raw data sensed. It may be provided that the radar image is received from a pre-processing device which receives the raw data and generates the radar image therefrom. For example, the radar image represents a driving situation of the vehicle in which the object is in the field of vision of the sensor. Other objects may be arranged in the field of vision.

In step 304, the pixels 202 of the radar image assigned to the object are provided. In step 404, the pixels 202 assigned to the object are, for example, determined in the radar image. The radar image may comprise other pixels assigned to other objects. These pixels are not taken into account.

The method comprises a step 306.

In step 306, the point cloud is provided.

The point cloud comprises at least one point 204, which represents the radar reflection assigned to the object, through at least one property of the object.

In the example, the at least one property is a position of the radar reflection within the point cloud, a backscatter cross-section, or a height.

The method comprises a step 308.

In step 308, the first features 208 are determined. For example, the pixels are mapped to the first features 208 by means of the first neural network 206.

The method comprises a step 310.

In step 310, the second features 212 are determined. For example, the points are mapped to the second features 212 by means of the second neural network 210.

The method comprises a step 312.

In step 312, the classification 216 of the object is determined depending on the first features 208 and the second features 212. For example, the first features 208 and the second features 212 are jointly mapped to the classification 216 by means of the third neural network 222.

In an optional step 314, a signal for controlling the at least one actuator 104 is determined depending on the classification 216.

It may be provided that the device 100 is designed to control at least one actuator 104 of a driver assistance function or of an autonomous vehicle. For example, the classification 216 is used to respond to a driving situation sensed via the at least one sensor 102. For example, at least one actuator 104 of an automatic emergency braking function, in particular a brake, is controlled by the signal, depending on the classification 216.

The device 100 is provided, for example, to avoid falsely positively classified objects. For example, falsely classified means that an object that can be driven over is misclassified as a two-wheeler, car, or pedestrian. For example, depending on the classification, the automatic emergency braking function is controlled to brake, if an object is, for example, classified as an object that cannot be driven over, as a two-wheeler, as a car, or as a pedestrian. For example, the at least one actuator 104 is not controlled to perform emergency braking, if an object is classified as an object that can be driven over.

For other applications, e.g., for controlling a robotaxi, the method is performed with a corresponding classification of objects and a correspondingly adapted model 200.

1-11. (canceled)

12. A computer-implemented method for determining a classification for an object, the method comprising the following steps:
providing pixels of a radar image that are assigned to the object; and
providing a point cloud, wherein the point cloud includes at least one point that represents a radar reflection assigned to the object, through at least one property assigned to the object;
extracting first features that characterize the object from the pixels;
extracting second features that characterize the object from the point cloud; and
determining the classification of the object depending on the first features and the second features.

13. The method according to claim 12, wherein the pixels are mapped to the first features using a first neural network trained for mapping the pixels to the first features, wherein the point cloud is mapped to the second features using a second neural network trained to map the point cloud to the second features, and wherein an input variable is determined depending on the first features and the second features, wherein the input variable is mapped to the classification using a third neural network trained to map the input variable to the classification.

14. The method according to claim 13, wherein the first neural network and the second neural network and the third neural network are trained independently of one another or that at least two of the first, second, and third neural networks are trained jointly.

15. The method according to claim 12, wherein raw data for determining the radar image are sensed by at least one sensor, and wherein the radar image is determined depending on the raw data sensed.

16. The method according to claim 12, wherein a signal for controlling at least one actuator is determined depending on the classification.

17. A device configured to determine a classification for an object, wherein the device is configured to:
provide pixels of a radar image that are assigned to the object;
provide a point cloud, wherein the point cloud includes at least one point that represents a radar reflection assigned to the object, through at least one property assigned to the object;
extract first features that characterize the object, from the pixels;
extract second features that characterize the object, from the point cloud; and
determine the classification of the object depending on the first features and the second features.

18. The device according to claim 17, wherein the device comprises at least one sensor configured to sense raw data for determining the radar image, wherein the device is configured to determine the radar image depending on the raw data sensed.

19. The device according to claim 17, wherein the device is configured to determine a signal for controlling at least one actuator, depending on the classification.

20. The device according to claim 17, wherein the device is configured to map the pixels to the first features using a first neural network trained to map the pixels to the first features, to map the point cloud to the second features using a second neural network trained to map the point cloud to the second features, to determine an input variable depending on the first features and the second features, and to map the input variable to the classification using a third neural network trained to map the input variable to the classification.

21. The device according to claim 20, wherein the device is configured to train the first neural network and the second neural network and the third neural network independently of one another, or to jointly train at least two of the first, second, and third neural networks.

22. A non-transitory machine-readable medium on which is stored a program including machine-readable instructions for determining a classification for an object, the instructions, when executed by a machine, causing performance of the following steps:
providing pixels of a radar image that are assigned to the object; and
providing a point cloud, wherein the point cloud includes at least one point that represents a radar reflection assigned to the object, through at least one property assigned to the object;
extracting first features that characterize the object from the pixels;
extracting second features that characterize the object from the point cloud; and
determining the classification of the object depending on the first features and the second features.
